(19) United States
(12) Patent Application Publication
(10) Pub. No.: US 2022/0357202 A1
(43) Pub. Date: Nov. 10, 2022

(54) DETECTOR ARRAY AND A SPECTROMETER SYSTEM

(71) Applicant: trinamix GmbH, Ludwigshafen am Rhein (DE)

(72) Inventors: Sebastian Valouch, Ludwigshafen (DE); Wilfried Hermes, Ludwigshafen (DE); Christoph Lungenschmied, Wien (AT); Jochen Brill, Ludwigshafen (DE); Robert Gust, Ludwigshafen (DE); Robert Send, Karlsruhe (DE); Bertram Feuerstein, Ludwigshafen (DE); Stefan Klueh, Ludwigshafen (DE)

(21) Appl. No.: 17/754,322

(22) PCT Filed: Sep. 30, 2020
(86) PCT No.: PCT/EP2020/077329

§ 371 Date: Mar. 30, 2022

(30) Foreign Application Priority Data
Oct. 1, 2019 (EP) 19200869.6

(51) Int. Cl. G01J 3/28; G01J 3/36

(52) U.S. Cl. CPC G01J 3/2803; G01J 3/2823; G01J 3/36; G01J 2003/2806

(57) ABSTRACT

Disclosed herein are a detector array, a spectrometer system including the detector array and a method of using of the spectrometer system. The detector array includes a substrate; and a plurality of detector pixels applied to a surface of the substrate, where each detector pixel has a sensor region which is designated for receiving a partition of incident light, where each detector pixel is designated for generating a sensor signal depending on an intensity of the partition of the incident light received by the sensor region of the detector pixel, where at least two adjacent detector pixels share a single connection to a common electric potential, and where the sensor regions of at least two of the detector pixels differ with respect to each other by an area of the corresponding sensor region.

### FIELD OF THE INVENTION

The invention relates to a detector array and to a spectrometer system comprising the detector array, and to various uses of the spectrometer system. The spectrometer system can, generally, be employed for various investigation or monitoring purposes, in particular in the infrared (IR) spectral region, especially in at least one of the near-infrared (NIR) and the mid infrared (MidIR) spectral region. However, other kinds of applications are feasible.

### PRIOR ART

Known spectrometer systems for the IR spectral region may, typically, be configured for transmission and/or reflection spectroscopy. For this purpose, the spectrometer device may comprise at least one wavelength selective element, such a linear variable filter element, a prism, a grating or the like, being configured for separating incident light into a spectrum of constituent wavelength signals. The respective intensities of those wavelength signals may be determined by employing at least one pixelated optical detector and/or at least one grating and at least one single pixel detector, also denoted as single pixel optical detector. In case of using the grating and the single pixel detector, a position of the grating may be changed gradually such that only one wavelength or a wavelength range having a narrow distribution may impinge on the single pixel detector. Specifically, the spectrometer device may be configured for absorption spectroscopy and may comprise, for example, at least one Fourier-transform infrared spectroscopy (FTIR) spectrophotometer. Herein, the spectrometer device may comprise at least one broadband light source and at least one interferometer, such as a Michelson interferometer. The FTIR spectrophotometer may be configured for illuminating the object with at least one light beam having a time-dependent spectrum. The FTIR spectrophotometer may comprise at least one moving mirror element, wherein by movement of the mirror element a light beam generated by the broadband light source is alternatingly blocked and transmitted by the interferometer. The spectrometer device may furthermore comprise at least one Micro Electro Mechanical System (MEMS) configured for controlling the mirror element. The FTIR spectrophotometer may be configured for modulating the light beam depending on the wavelength such that different wavelengths are modulated at different rates. The FTIR spectrophotometer may comprise at least one fixed detector configured for detect an absorption spectrum of the light beam having passed the object. For this purpose, the FTIR spectrophotometer may comprise at least one single pixel optical detector.

As an alternative, the spectrometer system may comprise a combination of at least one wavelength selective filter, at least one detector array and at least one evaluation unit. Herein, the wavelength selective filter may be designated for separating incident light into a spectrum comprising a plurality of wavelength-resolved partitions of the incident light while the detector array includes a plurality of detector pixels, wherein each detector pixel may be adapted to receive a partition of incident light, wherein each detector pixel may be designated for generating a sensor signal depending on an intensity of the partition of the incident light impinging on a corresponding sensor region, whereas the evaluation unit may be designated for determining information related to the spectrum by evaluating sensor signals provided by the detector array.

US 2014/131578 A1 discloses a portable spectrometer device which includes an illumination source for directing at a sample as well as a tapered light pipe (TLP) for capturing the light which interacts with the sample at a first focal ratio and for delivering the light at a second focal ratio lower than the first focal ratio to a linear variable filter (LVF). Preferably, the TLP is lensed at one end, and recessed in a protective boot with stepped inner walls. In addition, a gap between the TLP and LVF is minimized to further enhance resolution and robustness. It is emphasized here, that the TLP disclosed herein can also be denoted by the term “optical concentrator device”, wherein the optical concentrator device is operated in reverse direction for spreading out the captured light and reducing an angular spread of the captured light, wherein the optical concentrator device comprises a conical shape.

WO 2014/198629 A1 discloses a detector for determining a position of at least one object comprising at least one longitudinal optical sensor, the optical sensor being adapted to detect a light beam traveling from the object towards the detector. Herein, the longitudinal optical sensor has at least one matrix of pixels and at least one evaluation unit, the evaluation unit being adapted to determine a number N of pixels of the optical sensor which are illuminated by the light beam, the evaluation unit further being adapted to determine at least one longitudinal coordinate of the object by using the number N of pixels which are illuminated by the light beam.

WO 2019/115594 A1, WO 2019/115595 A1, and WO 2019/115596 A1 each discloses a spectrometer device comprising an optical element designed for receiving incident light from an object and transferring the incident light to a length variable filter, wherein these documents differ by various embodiments for the optical element; the length variable filter which is designated for separating the incident light into a spectrum of constituent wavelength signals; and a detector array having a plurality of detector pixel, wherein each detector pixel is adapted to receive at least a portion of one of the constituent wavelength signals, wherein each of the constituent wavelength signals is related to an intensity of each constituent wavelength. In a particular embodiment, a mono-chrome camera element, preferably a monochrome camera chip, may be used for the detector pixel, wherein the monochrome camera element may be differently selected for each pixel sensor, especially, in accordance with a varying wavelength along a series of the optical sensors.

Thus, known detector arrays, generally, comprise a plurality of detector pixel of the same type having identical extensions and being arranged in an equidistant manner with respect to each other within at least one line. By way of example, US 2014/131578 A1 discloses such an InGaAs linear diode array having a pixel pitch of 50 μm, wherein the detector array is separated by a gap of less than 200 μm form the LVF for increasing spectral resolution, wherein the gap ensures that a single line on the LVF creates a pixel-wide line on the detector array. As a result of this embodiment, the array of the pixels is designed for recording and generating a high-resolution spectrum, wherein a multitude of peaks in the spectrum can be determined each by forming an integral using a computer program configured for this purpose.

However, in many cases, recording and generating a high-resolution spectrum is not required. Still, the high-resolution array and the electronics surrounding it are cost-intensive while the computer program contributes to further complications.

U.S. Pat. No. 9,696,205 B2 discloses an array type light-receiving device which includes a plurality of pixels two-dimensionally arranged in a first direction and a second direction perpendicular to the first direction, each of the pixels including a light-receiving layer having a responsivity to a wavelength of light. The pixels arranged in the second direction constitute a plurality of pixel lines extending in the second direction, the plurality of pixel lines being arranged in the first direction to form an array. The pixels in each of the pixel lines have different pixel areas from each other. In addition, the pixel area of each of the pixels included in at least one of the pixel lines is determined in accordance with the responsivity to a wavelength of light received by each of the pixels.

U.S. Pat. No. 8,314,866 B2 discloses a color pixel array which includes a plurality of micropixels. Each micropixel includes a photosensitive element and a color filter optically aligned with the photosensitive element to filter incident light prior to reaching the photosensitive element. The micropixels are organized into a repeating pattern of triangular macropixels each having a triangular shape within the color pixel array.

US 2017/0241838 A1 discloses an optical filter element for devices for converting spectral information into location information which uses a connected detector for detecting signals. The element has at least two microresonators, each comprising at least two superposed reflective layer structures of a material layer having a high refractive index and a material layer having a low refractive index in an alternating sequence, and at least one superposed resonance layer arranged between the two superposed reflective layer structures. The filter element comprises at least one transparent plane-parallel substrate for optically decoupling the two microresonators; the first microresonator being located on a first of two opposing surfaces of said substrate, and the second microresonator being located on said substrate on a second surface thereof that lies opposite the first surface. The resonance layer of at least one microresonator, and/or the reflective layer structure that surrounds said resonance layer, has a layer thickness which can vary along a horizontal axis of said filter element.

### Problem Addressed by the Invention

Therefore, the problem addressed by the present invention is that of providing a detector array and a spectrometer system which are, particularly, suited for the IR spectral region, especially the NIR and the MidIR spectral regions, which at least partially avoid the disadvantages of known detector arrays and spectrometer systems.

In particular, it would be desirous to have a simple, cost-efficient and, still, reliable detector array and a related spectrometer system comprising such a detector array which allow determining information about a spectrum with as little electronics surrounding the detector array as possible and with a simpler computer program configured for this purpose.

### SUMMARY OF THE INVENTION

This problem is solved by the invention with the features of the independent patent claims. Advantageous developments of the invention, which can be implemented individually or in combination, are presented in the dependent claims and/or in the following specification and the detailed embodiments.

As used herein, the expressions “have”, “comprise” and “contain” as well as grammatical variations thereof are used in a non-exclusive way. Thus, the expression “A has B” as well as the expression “A comprises B” or “A contains B” may both refer to the fact that, besides B, A contains one or more further components and/or constituents, and to the case in which, besides B, no other components, constituents or elements are present in A.

In a first aspect of the present invention, a detector array is disclosed. Herein, the detector array comprises:
a substrate; and
a plurality of detector pixels applied to a surface of the substrate,
wherein each detector pixel has a sensor region which is designated for receiving a partition of incident light,
wherein each detector pixel is designated for generating a sensor signal depending on an intensity of the partition of the incident light received by the sensor region of the detector pixel, wherein at least two adjacent detector pixels share a single connection to a common electric potential, and
wherein the sensor regions of at least two of the detector pixels differ with respect to each other by an area of the corresponding sensor region.

The present invention can, in particular, be employed for determining information related to a spectrum which may be related to an object. The “object” may, generally, be an arbitrary body, chosen from a living object and a non-living object. Thus, as an example, the at least one object may comprise one or more articles and/or one or more parts of an article, wherein the at least one article or the at least one part thereof may comprise at least one component which may provide a spectrum suitable for investigations. Additionally or alternatively, the object may be or may comprise one or more living beings and/or one or more parts thereof, such as one or more body parts of a human being, e.g. a user, and/or an animal.

As used herein, the term “light”, generally, refers to a partition of electromagnetic radiation which is, usually, referred to as “optical spectral range” and which comprises one or more of the visible spectral range, the ultraviolet spectral range and the infrared spectral range. Herein, the term “ultraviolet spectral range”, generally, refers to electromagnetic radiation having a wavelength of 1 nm to 380 nm, preferably of 100 nm to 380 nm. Further, in partial accordance with standard ISO-21348 in a valid version at the date of this document, the term “visible spectral range”, generally, refers to a spectral range of 380 nm to 760 nm. The terms “infrared spectral range” or “IR”, generally, refer to electromagnetic radiation of 760 nm to 1000 μm, wherein the range of 760 nm to 1.5 μm is usually denominated as “near infrared spectral range” or “NIR” while the range from 1.5μ to 15 μm is denoted as “mid infrared spectral range” or “MidIR” and the range from 15 μm to 1000 μm as “far infrared spectral range” or “FIR”. Preferably, light used for the purposes of the present invention may be light in the IR spectral range, more preferred in at least one of the NIR and the MidIR spectral ranges, especially having a wavelength of 1 μm to 5 μm, preferably of 1 μm to 3 μm.

Light emerging from the object can originate in the object itself, but can also optionally have a different origin and propagate from this origin to the object and subsequently toward the detector array. The latter case can, in particular, be affected by at least one illumination source being used. Thus, the light propagating from the object to the detector array may be light which may be reflected by the object and/or a reflection device connected to the object. Alternatively or in addition, the light may at least partially transmit through the object. The illumination source can be embodied in various ways. Thus, the illumination source can be for example part of the spectrometer system in a housing. Alternatively or additionally, however, the at least one illumination source can also be arranged outside a housing, for example as a separate light source. The illumination source can be arranged separately from the object and illuminate the object from a distance. As indicated above, the illumination source can, alternatively or in addition, also be connected to the object or be part of the object, such that, by way of example, the electromagnetic radiation emerging from the object can also be generated directly by the illumination source. By way of example, at least one illumination source can be arranged on and/or in the object and directly generate the electromagnetic radiation.

The illumination source may, preferably, comprise a kind of light source which is known to provide sufficient emission in the IR spectral range, especially in at least one of the NIR or MidIR spectral ranges, in particular, a thermal radiation source. As used herein, the term “thermal radiation source” refers to a light source which is configured for emitting light by a radiation emitting element in a thermal process, especially in at least a partition of the visible and IR spectral ranges. In particular, the thermal radiation source may be selected from an incandescent lamp or a thermal infrared emitter. As generally used, the terms “incandescent lamp”, “incandescent light bulb” or “incandescent light globe” relate to a device having a volume confined by a bulb, in particular of glass or fused quartz, wherein a wire filament, which may, specifically, comprise tungsten, is located as the radiation emitting element in the volume, preferably filled with inert gas or comprising a vacuum, where it emits the radiation to be monitored. As further general used, the term “thermal infrared emitter” refers to a micro-machined thermally emitting device which comprises a radiation emitting surface as the radiation emitting element. By way of example, thermal infrared emitters are available under the name “emirs50” from Axetris AG, Schwarzenbergstrasse 10, CH-6056 Kägiswil, Switzerland, as “thermal infrared emitters” from LASER COMPONENTS GmbH, Werner-von-Siemens-Str. 15 82140 Olching, Germany, or as “infra-red emitters” from Hawkeye Technologies, 181 Research Drive #8, Milford Conn. 06460, United States. However, other types of thermal infrared emitter may also be feasible.

Alternatively or in addition, the illumination source may, be selected from at least one of the following illumination sources: a flame source; a heat source; a laser, in particular a laser diode, although further types of lasers can also be used; a light emitting diode; an organic light source, in particular an organic light emitting diode; a neon light; a structured light source. Alternatively or additionally, other illumination sources can be used. Herein, it may particularly be preferred when the light emitted by the object and/or by the illumination source may exhibit a spectral range which may be closely related to the spectral sensitivities of the detector array, particularly, in a manner to ensure that the detector array which may be illuminated by the respective illumination source may be capable of providing a sensor signal having a high intensity, thus, enabling an evaluation of the sensor signals with sufficient signal-to-noise-ratio.

As generally used, the term “spectrum” refers to a partition of the optical spectral range, in particular, of the IR spectral range, especially of at least one of the NIR or M idIR spectral ranges. Herein, each part of the spectrum is constituted by an optical signal which is defined by a signal wavelength and the corresponding signal intensity. Thus, the term “spectrometer system” relates to an apparatus which is capable of recording the signal intensity with respect to the corresponding wavelength of a spectrum or a partition thereof, such as a wavelength interval, wherein the signal intensity may, preferably, be provided as an electrical signal which may be used for further evaluation. As described below in more detail, the spectrometer system according to the present invention has a wavelength selective filter, in particular a length variable filter, specifically a linear variable filter, which is designated for separating incident light into a spectrum comprising a plurality of wavelength-resolved partitions whose respective intensities are determined by employing the detector array as described below in more detail. In addition, an optical element being designed for receiving incident light from the object and transferring the incident light to the wavelength selective filter can be applied. In addition, the spectrometer system comprises an evaluation unit which is designated for determining information related to a spectrum by evaluating sensor signals provided by the detector array as disclosed herein.

In accordance with the present invention, the detector array comprises a plurality of imaging elements which are denoted herein by the term “detector pixels”. As generally used, the term “detector array” refers to a pixelate sensor comprising at least a substrate, wherein the plurality of the individual detector pixels is applied to a surface of the substrate, such as to a front surface and/or to a back surface of the substrate. Herein, the term “front” denotes that the respective surface of the substrate is oriented towards a direction of the incident light, specifically towards a wavelength selective filter as described below in more detail. Similarly, the term “back” denotes that the respective surface of the substrate is oriented away from the direction of the incident light. As described below in more detail, the detector array may, further, comprise additional elements which are can be designed for generating sensor signals associated with the intensity of the incident light impinging on the individual detector pixel, such as at least two electrodes of different polarity attached to a boundary of the sensor region and leads from the electrodes to an evaluation unit which is designated for determining information by evaluating the sensor signals provided by the detector pixels.

As generally used, the expression “substrate” refers to a carrier element providing mechanical stability to the detector array. Herein, the substrate may be a transparent substrate, specifically when the plurality of the detector pixels is applied to the back surface of the substrate or, an intransparent absorptive substrate, in particular in order to minimize any reflection of light from the surface of the substrate. As an example, the substrate may be a plate-shaped substrate, such as a slide and/or a foil. The substrate may, in general, have a thickness of 300 μm, preferably of 500 μm, to 1.5 mm, preferably to 1 mm. However, other thicknesses are feasible.

Preferably, the plurality of the detector pixels may be arranged in series in a single line as a one-dimensional matrix along a length of the wavelength selective filter or, in an alternative embodiment, in more than one line, especially as two, three, or four parallel lines, especially in form of a two-dimensional matrix. Thus, a number N of pixels in one direction may be higher compared to a number M of pixels in a further direction such that the one-dimensional 1×N matrix or a rectangular two-dimensional M×N matrix may be obtained, wherein M is at least 1 but preferably not more than 4, most preferred 1 or 2, while N is of 2, preferably of 10, more preferred of 50, to 5000, preferably to 1000, more preferred to 600.

For the purpose of receiving a partition of incident light, each detector pixel has a sensor region. As generally used, the term “sensor region” refers to a photosensitive area which comprises a photosensitive material which is designated, upon receiving a partition of the incident light, for generating electric charges which can be used for generating the desired sensor signals. Herein, the material for the detector pixel may be selected from any known material which can be used for this purpose. In particular, a semiconducting material, preferably selected from silicon or GaAs, which are commonly used in pixelated inorganic camera elements, such as pixelated inorganic camera chips, in particular CCD chips or CMOS chips, are applicable. As a preferred alternative, a photoconductive material, preferably selected from at least one of PbS, PbSe, Ge, InGaAs, ext. InGaAs, InSb, or HgCdTe, as described below in more in more detail may be used. As a further alternative, organic semiconductors as known from pixelated organic camera elements, such as pixelated organic camera chips, can also be used. As a further alternative, the sensor area may comprise a material which can be used in at least one of a pyroelectric, bolometer or thermopile detector element.

Further according to the present invention, each detector pixel is designated for generating a sensor signal depending on an intensity of the partition of the incident light received by the sensor region of the corresponding detector pixel. For this purpose, at least two, preferably exactly two, electrodes of different polarity may be attached to a boundary of the sensor region of the individual detector pixel for receiving electric charges which may be generated by the incident light within the sensor region. Thus, the individual detector pixel is designed to generate sensor signals, preferably in form of electronic signals, which are associated with the intensity of the incident light that impinges on the individual detector pixel. Herein, the sensor signal may be an analogue and/or a digital signal. Accordingly, the sensor signals for adjacent detector pixels can, thus, be generated simultaneously or in a successive manner. By way of example, during a row scan or line scan, it is possible to generate a sequence of electronic signals which correspond to the series of the individual detector pixels which are arranged in a line. In addition, the individual detector pixels may, preferably, be active detector pixels, wherein the term “active” indicates that this particular kind of detector pixel is adapted to amplify the electronic signals prior to providing them to an external evaluation unit. For this purpose, the detector pixel may additionally comprise at least one signal processing device, such as an optical filter and/or an analogue-digital-converter for processing and/or preprocessing the electronic signals.

According to the present invention, the sensor regions of at least two of the detector pixels, preferably of two, three, four, five, six or more of the detector pixels, more preferred of a predominant number of the detector pixels within the detector array, in particular of all detector pixels within the detector array, differ with respect to each other by an area of the corresponding sensor region. As generally used, the term “predominant number” indicates that a first number of detector pixels within the detector array which correspond to the feature of the differing areas of the corresponding sensor regions outnumbers a second number of detector pixels within the same detector array which do not correspond to this feature. As used herein, the term “differ” with respect to at least two areas of the sensor region indicates that a size of the at least two areas is different from each other by a value of at least 10%, preferably of at least 25%, more preferred of at least 50%.

As generally used, the term “area” with regard to the sensor region relates to a size of a surface of the senor region which is directed towards he incident light and can, thus, be impinged by the incident light. Herein, the area of the senor region can, preferably, be selected from a triangular, a quadrangular, or a hexagonal shape, wherein a rectangular shape, including a square shape, may be preferred. However, other kinds of shapes, in particular a further kind of a quadrangular shape, such as a rhomboid or trapezoidal shape, or even an irregularly formed shape, may also be feasible.

Further, the at least two, the preferably exactly two, electrodes of different polarity which are attached to the boundary of the sensor region of the individual detector pixel may, accordingly, exhibit a size and shape which may be adjusted to the actual size and shape of the sensor region. As illustrated below in more detail, an extension of the electrode may vary in accordance with the corresponding extension of the respective sensor region where it is attached to.

In a particularly preferred embodiment, in which the detector pixels may be arranged on the substrate in a single line, a line of orientation of an arrangement of the detector pixels within the detector array may be specified, in particular by defining the line of orientation along the direction of the single line. Exemplary embodiments for the line of orientation can be found below. Accordingly, in this particularly preferred embodiment, the area of each sensor region can be aligned in a first direction and in a second direction, wherein the first direction can, preferably, be chosen as parallel to the line of orientation of the detector pixels, whereas the second direction can, preferably, be chosen as perpendicular to the line of orientation of the detector pixels. As used herein, the term “perpendicular” refers to an angle of 90°±5°, preferably of 90°±1°, preferably of 90°±0.1°, with respect to the line of orientation. Similarly, the term “parallel” relates to an angle of 0°±5°, preferably of 0°±1°, preferably of 0°±0.1°, with respect to the line of orientation.

In this particularly preferred embodiment, the sensor regions of the at least two of the detector pixels may, therefore, differ with respect to each other by an extension in at least one of: the first direction and the second direction. By way of example, the extensions of the at least two of the detector pixels may differ with regard to the first direction while the extensions of the at least two of the detector pixels may be the same or, within a tolerance level, similar with regard to the second direction, or vice versa. A particular example for this particular embodiment can be found below.

In a further preferred embodiment, the at least two of the detector pixels may further differ with respect to each other by at least one of:
a distance between the detector pixels; and
a density of the detector pixels on a respective section of the substrate.

As generally used, the term “distance” relates to a spacing between two adjacent detector pixels, wherein the distance can be indicated in a linear unit, such as in μm or mm, either between the center or, as an alternative, between two adjoining boundaries of the adjacent detector pixels. Similarly, the term “density” refers to a frequency of occurrence of the detector pixels within a respective section of the substrate on which the detector pixels are located. In this respect, it is indicated that the term “pixel pitch” which is, generally, used for known pixel-based devices refers to both a distance between two adjacent detector pixels, which can be indicated in the linear unit, such as in μm or mm, and to the frequency of occurrence of the pixels which, can be indicated as a rate, such as dots per inch (dpi), wherein the term “dot” is identical with the expression “detector pixel”. However, it is explicitly emphasized that, while the frequency of occurrence in known pixel-based devices is identical over the whole device due to the equal spacing of the pixels over the whole device, the frequency of occurrence of the pixels in the detector array according to the present invention depends on the particular location of the detector pixel under question.

In a particularly preferred embodiment, the area of the at least one of the detector pixels can be adjusted to a spectral property of the partition of the incident light which impinges on the corresponding sensor region of the detector pixel, preferably after having passed the wavelength selective filter. As generally used, the expression “spectral property” relates to a characteristic of the spectrum which impinges the detector array. In particular, the spectral property may, preferably, be selected from at least one of: a width of a peak within the spectrum of the incident light, a bandwidth of the wavelength selective filter, a variation of an emission spectrum of an illumination source illuminating an object generating the spectrum. By way of example, the area of the detector pixels can be adjusted to a variation of the intensity of the incident light which can be generated by an incandescent lamp which disadvantageously decreases above a wavelength of approx. 2000 nm. Consequently, increasing the areas of the detector pixels which are designed for receiving incident light of a longer wavelength in a corresponding fashion can be used for compensating this disadvantage.

In this particularly preferred embodiment, the area of the at least one of the detector pixels can, thus, be adjusted to a variation of the bandwidth of the incident light, in particular after the incident light has passed the wavelength selective filter, in particular a length variable filter, specifically a linear variable filter, wherein the area may, specifically, vary in accordance with varying transmittance properties of the wavelength selective filter along the series of the optical sensors within the line orientation. By way of example, the wavelength selective filter may be more selective at a first end designed for receiving short wavelengths compared to a second end designed for receiving long wavelengths. Specifically, a linearly variable filter (LVF) as described below in more detail having a resolution of 1% corresponds to a distribution of 15 nm at a wavelength of 1500 nm and to a distribution of 24 nm at a wavelength of 2400 nm. However, other kinds of adjustments may also be feasible.

Thus, in contrast to WO 2019/115596 A1, wherein each of the optical sensors used in the series of the optical sensors may exhibit a varying optical sensitivity that may vary in accordance with varying transmittance properties of the wavelength selective filter, such as by providing an increasing variation or a decreasing variation of the optical sensitivity with wavelength along the series of the optical sensors, the detector pixels in the detector array used herein may exhibit the same or, within a tolerance level, a similar optical sensitivity, wherein the adjustment to the varying transmittance properties to the wavelength selective filter can still achieved by the variation of the area of the sensor regions according to the present invention. Alternatively or in addition, the area of the at least one of the detector pixels can, therefore, be adjusted to the peak width of one or more peaks in the spectrum to be analyzed to ensure that the sensor signal which is provided by the at least one of the detector pixels corresponds to an intensity of the peak. By way of example, a particular spectrum may exhibit a first prominent peak having a maximum intensity at a first wavelength and, in addition, a second, however, less prominent peak having a maximum intensity at a second wavelength. In this example, a first area and a first location of a first detector pixel can be adjusted to the first wavelength and the first width of the first peak, whereas a second area and a second location of a second detector pixel can be adjusted to the second wavelength and the second width of the second peak. As a result thereof, a first intensity of the first peak can be determined by recording a first sensor signal associated to the first detector pixel, while a second intensity of the second peak can, consecutively or, preferably, simultaneously, be determined by recording a second sensor signal associated to the second detector pixel. However, further kinds of embodiments and examples may also be conceivable.

In a particular embodiment thereof, the evaluation unit can, specifically, be designated for determining a relationship between an intensity of two different peaks, wherein the relationship between the intensity of the two different peaks may be determined by evaluating the sensor signals of the two detector pixels, in particular by using an adapted software or, alternatively or in addition, an analogue electronic circuit. In the above example, a ratio of a first sensor signal of the first detector pixel versus a second sensor signal of the second detector pixel may be determined in this fashion, whereby a ratio of an intensity of the first peak as recorded by the first detector pixel versus an intensity of the second peak as recorded by the second detector pixel can be obtained. However, other examples may also be feasible.

In a further particularly preferred embodiment, the photosensitive material as used for the sensor regions of the detector pixels may be a photoconductive material, preferably selected from at least one of PbS, PbSe, Ge, InGaAs, ext. InGaAs, InSb, or HgCdTe. However, other kinds of photoconductive materials can also be used for this purpose. As generally used, the term “photoconductive material” refers to a material which is capable of sustaining an electrical current in the sensor region and, therefore, exhibits a specific electrical conductivity, wherein the electrical conductivity is dependent on the illumination of the photoconductive material. Since an electrical resistivity is defined as the reciprocal value of the electrical conductivity, the term “photoresistive material” may, alternatively, be used to denominate the same kind of material. However, in contrast to other photosensitive materials, adjacent detector pixels cannot be simply connected with regard to each other by connecting their electrodes to form a single detector pixel. Rather, the area of each detector pixel having a photoconductive material in the sensor region defines the electrical resistivity of the detector pixels.

In this particularly preferred embodiment, the areas of the at least two of the detector pixels can, therefore, preferably be adjusted in order to align the electrical resistivity of the corresponding sensor regions of the at least two of the detector pixels. As indicated above, the electrical conductivity of the corresponding sensor regions of the at least two of the detector pixels could, equally, be adjusted. As used herein, the term “aligning” relates to achieving the same or, within a tolerance level, a similar electrical resistivity or electrical conductivity of the involved sensor regions of the at least two of the detector pixels. As the person skilled in the art knows, aligning the electrical resistivity or the electrical conductivity of the sensor region could, preferably be achieved by aligning the respective areas of the sensor regions since the electrical resistivity of the sensor region is well-known to be a function, in particular a linear function, of the area of the sensor region, while the electrical conductivity of the sensor region is well-known to be an inverse function, in particular a reciprocal function, of the area of the sensor region. Alternatively or in addition, the person skilled in the art could also easily determine the electrical resistivity or the electrical conductivity of the sensor region in an experimental fashion. By way of example, the respective areas of the detector pixels could be chosen in a manner as illustrated below. As a result thereof, an identical amplification factor can, advantageously, be used for the detector pixels in a photoconductive array in which each detector pixel exhibits the same or a very similar electrical resistivity and electrical conductivity.

In a further preferred embodiment of the present invention, one of at least two types of connection may be used for connecting the detector pixels to a power supply which is configured to provide the desired current to each detector pixel. In particular, the type of connection can be selected from a single connection for each detector pixel for both electrodes of the detector pixel or, as used herein, from providing a common electric potential for at least two adjacent detector pixels, wherein the common electric potential may interconnect the corresponding electrodes of the detector pixels having the same polarity which are located on the same side of the detector array. In addition, a combination of both types of connection may be feasible. By way of example, a first number and a second number of detector pixels may individually be interconnected by a first common electric potential and a second common electric potential, respectively. As described below in more detail, a common electric potential which provides interconnection on one side of the detector array exhibits various benefits for the read-out electronics whereas single electrodes exhibit different advantages, in particular that a current through each detector pixel and a responsivity of each detector pixel N can be adjusted individually by using the individual power supplies.

Irrespective which type of connection may be selected for the detector pixels, the detector array may be adapted to provide a plurality of the sensor signals, in particular in form of electrical signals, which may be generated by the sensor regions of the detector pixels comprised by the detector array. The sensor signals as provided by the individual detector pixels of the detector array may, subsequently, be forwarded to an external evaluation unit, in particular, to an evaluation unit which may be comprised by the corresponding spectrometer system as described below in more detail. Herein, the term “evaluation unit” refers to an apparatus being designated for determining information related to the spectrum of the object of which a spectrum has been recorded, in particular, by using the detector array as described herein, wherein the information can be obtained by evaluating the sensor signals. The information may, for example, be provided electronically, visually, acoustically or in any arbitrary combination thereof. Further, the information may be stored in a data storage device of the spectrometer system, or of a separate storage device and/or may be provided via at least one interface, such as a wireless interface and/or a wire-bound interface.

In a further aspect of the present invention, a spectrometer system is disclosed. Accordingly, the spectrometer system comprises
a wavelength selective filter which is designated for separating incident light into a spectrum comprising a plurality of partitions of the incident light;
a detector array as described above and/or below in more detail; and
an evaluation unit designated for determining information related to a spectrum of an object by evaluating sensor signals provided by the detector array.

Herein, the components of the spectrometer system as listed above may be individual components. Alternatively, two or more of the components of the spectrometer system may be integrated into a single integral component. Further, the evaluation unit may be formed as an individual evaluation unit independent from the spectrometer system but may preferably be connected to the spectrometer system, in particular, in order to receive the sensor signals generated by the detector array. Alternatively, the at least one evaluation unit may fully or partially be integrated into the at least one spectrometer system.

Thus, the spectrometer system comprises a wavelength selective filter which is designated for separating incident light into a spectrum comprising a plurality of wavelength-resolved partitions. Preferably, the wavelength selective filter may be length variable filter, however, other kinds of wavelength selective filters may also be feasible. As generally used, the term “length variable filter” refers to an optical filter which comprises a plurality of filters, preferably a plurality of interference filters, which may, in particular, be provided in a continuous arrangement of the filters. Herein, each of the filters may form a bandpass with a variable center wavelength for each spatial position on the filter, preferably continuously, along a single dimension, which is, usually, denoted by the term “length”, on a receiving surface of the length variable filter. In a preferred example, the variable center wavelength may be a linear function of the spatial position on the filter, in which case the length variable filter is usually referred to as a “linearly variable filter” or by its abbreviation “LVF”. However, other kinds of functions may be applicable to the relationship between the variable center wavelength and the spatial position on the filter. Herein, the wavelength selective filter may be located on a transparent substrate which may, in particular, comprise at least one material that may show a high degree of optical transparency within in the IR spectral range, especially within at least one of the NIR or MidIR spectral ranges, whereby varying spectral properties, especially continuously varying spectral properties, of the filter along length of the filter may be achieved. In particular, the length variable filter may be a wedge filter that may be adapted to carry at least one response coating on a transparent substrate, wherein the response coating may exhibit a spatially variable property, in particular, a spatially variable thickness. However, other kinds of wavelength selective filters which may comprise other materials or which may exhibit a further spatially variable property may also be feasible. At a normal angle of incidence of an incident light beam, each of the filters as comprised by the length variable filter may have a bandpass width that may amount to a fraction of the center wavelength, typically to a few percent, of the particular filter. By way of example, for a length variable filter having a wavelength range from 1400 to 1700 nm and a bandpass width of 1%, the bandpass width at the normal incidence angle might vary from 14 nm to 17 nm. However, other examples may also be feasible, such as a resolution of 1% over the wavelength range, e.g. resulting in a distribution of 15 nm at a wavelength of 1500 nm and a distribution of 24 nm at a wavelength of 2400 nm.

As a result of this particular set-up of the length variable filter, only incident light having a wavelength which may, within a tolerance indicated by the bandpass width, equal the center wavelength being assigned to a particular spatial position on the filter is able to pass through the length variable filter at the particular spatial position. Thus, a “transmitting wavelength” which may be equal to the center wavelength ±½ of the bandpass width may be defined for each spatial position on the length variable filter. In other words, all light which may not pass through the length variable filter at the transmitting wavelength may be absorbed or, mostly, reflected by the receiving surface of the length variable filter. As a result, the length variable filter has a varying transmittance which may enable it for separating the incident light into a spectrum. It is emphasized here that similar consideration may be applicable to other kinds of wavelength selective filters.

Thus, the light which may pass through the wavelength selective filter at a particular spatial position on the wavelength selective filter may, subsequently, impinge on a detector array. In other words, the detector array may, preferably, be placed in a manner that the light may first impinge on the wavelength selective filter and only that the partition of the light which may pass through the particular spatial position on the wavelength selective filter may, thereafter, be capable of impinging on a corresponding spatial position on the detector array. As a result, the wavelength selective filter may, therefore, be used for separating the incident light by its associated wavelength or wavelengths into at least one corresponding spatial position while a particular optical sensor comprised by the detector array may, consequently, be employed for measuring an intensity of the incident light which, due to its particular wavelength, may be able to pass through the wavelength selective filter at the corresponding spatial position and, therefore, impinge the particular optical sensors provided for determining the intensity of the incident light at the particular wavelength.

In particular embodiment, the detector array may, preferably, be separated from the length variable filter by a transparent gap. Herein, the transparent gap may, by way of example, be obtained by using an extended transparent body having two opposing sides, wherein the plurality of the interference filters which may constitute the length variable filter may be disposed on a first side while the series of the optical sensors constituting the detector array may be placed on a second side opposing the first side. As a result, by selecting a suitable width for the transparent gap a more precise adjustment of the detector array with regard to the length variable filter can be achieved.

With respect to further details of the detector array, reference may be made to the description thereof elsewhere in this document.

In a further preferred embodiment, the spectrometer system may further comprise an optical element which is designated for receiving incident light from the object and transferring the incident light to the wavelength selective filter. For this purpose, the optical element may be or comprise an optical concentrator device which can be operated in reverse direction. As generally used, the term “optical concentrator” refers to a non-imaging optical element having an input, also denoted as “entrance pupil” or “entrance aperture”, an output located oppositely to the input, wherein the output may also be denoted by one of the terms “exit pupil” or “exit aperture”, and an optically guiding structure located between the input and the output, wherein the optical concentrator is, in normal direction of operation, adapted for capturing light at the input at a large angular spread, concentrating the captured light within the optically guiding structure, and emitting the concentrated light at the output. Using the optical concentrator device in a reverse direction, in which the previous output of the optical concentrator now serves as input for receiving incident light, while the optically guiding structure in the reverse direction, serves for spreading out the incident light, whereas the previous input now serves as output for emitting the spread light. As a result, the optical concentrator device which is operated in reverse direction may, thus, be selected and arranged in a fashion that the emitted light beams can impinge on the wavelength selective filter within the restricted angular range.

Various shapes of optical concentrator devices which are operated in normal direction have been presented before. Apart from optical concentrator devices having a conical shape which is known to suffer from low concentration efficiency, further possible optical concentrator devices can assume a shape in a fashion that they may be referred to as a “compound parabolic concentrator” or “CPC” or a “compound elliptical concentrator” or “CEC” while further shapes, in particular a “compound hyperbolic concentrator” or “CHC”, may be less suited for the purposes of the present invention. Herein, the inversely-operated optical concentrator device having the non-conical shape may be or may comprise a full body of a fully or partially optically transparent material or, as an alternative, may be or may comprise a hollow body which can be, preferably fully and/or uniformly, filled with a gaseous and/or fluid and/or solid optically transparent material and which comprises at least two individual sidewalls that may assume the desired non-conical shape. Herein, the at least one material that may show a high degree of optical transparency within in the IR spectral range, especially within at least one of the NIR and MidIR spectral ranges, and which can be chosen for the full body of the optical concentrator device may, preferably, be selected from the group consisting of calcium fluoride (CaF₂,), fused silica, germanium (Ge), magnesium fluoride (MgF), potassium bromide (KBr), sapphire, silicon (Si), sodium chloride (NaCl), zinc selenide (ZnSe), zinc sulfide (ZnS), borosilicate glasses, transparent conducting oxides (TCO), and transparent organic polymers, wherein silicon and germanium having high reflective indices are particularly preferred since they are capable of supporting total reflection which may occur on the sidewalls of the full body. As an alternative, the gaseous optically transparent material which may be chosen for filling the hollow body having at least two sidewalls showing the desired non-conical shape may be selected from ambient air, nitrogen gas, or carbon dioxide while the fluid optically transparent material for this purpose may be chosen from immersion oil or Canada balsam, i.e. a turpentine made from the resin of a balsam fir tree, especially from ablies balsamea. As a further alternative, a vacuum may be present in the hollow body.

For further details with respect to the inversely-operated optical concentrator device reference may be made to US 2014/131578 A1, in which the inversely-operated optical concentrator device, the wavelength selective filter, and the detector array are arranged in a symmetrical manner with regard to a common optical axis of the spectrometer system and to WO 2019/115594 A1, WO 2019/115595 A1, and WO 2019/115596 A1, each of which discloses a kind of asymmetry within the inversely-operated optical concentrator device and/or its arrangement with regard to the common optical axis of the spectrometer system.

Alternatively or in addition, the spectrometer system according to the present invention may comprise at least one transfer device, which can be used as the optical element or may be arranged between the optical element, especially the inversely-operated optical concentrator device, and the wavelength selective filter. As generally used, the term “transfer device” refers to an optical component which can be configured to transfer the light beam to the detector array. In a particular embodiment, the transfer device can, thus, be designed to shape the light beam before it may be guided to the wavelength selective filter. In particular, the transfer device may be selected from a group consisting of an optical lens, a curved mirror, a grating, and a diffractive optical element. More particular, the optical lens may, especially, be selected from a group consisting of a biconvex lens, a plano-convex lens, a biconcave lens, a plano-concave lens, an aspherical lens, a cylindrical lens and a meniscus lens. Hereby, the transfer device may comprise a material which may be at least partially transparent, preferably over the whole wavelength range of the wavelength selective filter as indicated above. For this purpose, the same or similar optically transparent materials as mentioned in this respect can also be used. However, further optical elements may also be feasible.

Further, the spectrometer system comprises an evaluation unit. As further used herein, the term “evaluation unit”, generally, refers to an arbitrary device designed to generate the desired items of information, i.e. the at least one item of information related to the spectrum of the object. As an example, the evaluation unit may be or may comprise one or more integrated circuits, such as one or more application-specific integrated circuits (ASICs), and/or one or more data processing devices, such as one or more of computers, digital signal processors (DSP), field programmable gate arrays (FPGA) preferably one or more microcomputers and/or microcontrollers. Additional components may be comprised, such as one or more preprocessing devices and/or data acquisition devices, such as one or more devices for receiving and/or preprocessing of the sensor signals, such as one or more AD-converters and/or one or more electronic filters. As used herein, the sensor signal is provided by the detector array. Further, the evaluation unit may comprise one or more data storage devices. Further, the evaluation unit may comprise one or more interfaces, such as one or more wireless interfaces and/or one or more wire-bound interfaces.

The at least one evaluation unit may be adapted to perform at least one computer program, such as at least one computer program performing or supporting the step of generating the items of information. As an example, one or more algorithms may be implemented which, by using the sensor signals as input variables, may perform a predetermined transformation into the position of the object. For this purpose, the evaluation unit may, particularly, comprise at least one data processing device, in particular an electronic data processing device, which can be designed to generate the items of information by evaluating the sensor signals. Thus, the evaluation unit is designed to use the sensor signals as input variables and to generate the items of information related to the spectrum of the object by processing these input variables. The processing can be done in parallel, subsequently or even in a combined manner. The evaluation unit may use an arbitrary process for generating these items of information, such as by calculation and/or using at least one stored and/or known relationship. Besides the sensor signals, one or a plurality of further parameters and/or items of information can influence said relationship, for example at least one item of information about a relative arrangement of the optical element, the wavelength selective filter, and the detector array. The relationship can be determined or determinable empirically, analytically or else semi-empirically. Particularly preferably, the relationship comprises at least one calibration curve, at least one set of calibration curves, at least one function or a combination of the possibilities mentioned. One or a plurality of calibration curves can be stored for example in the form of a set of values and the associated function values thereof, for example in a data storage device and/or a table. Alternatively or additionally, however, the at least one calibration curve can also be stored for example in parameterized form and/or as a functional equation. Separate relationships for processing the sensor signals into the items of information may be used. Alternatively, at least one combined relationship for processing the sensor signals is feasible. Various possibilities are conceivable and can also be combined.

By way of example, the evaluation unit can be designed in terms of programming for the purpose of determining the items of information. The evaluation unit can comprise, in particular, at least one computer, for example at least one microcomputer. Furthermore, the evaluation unit can comprise one or a plurality of volatile or nonvolatile data memories. As an alternative or in addition to a data processing device, in particular at least one computer, the evaluation unit can comprise one or a plurality of further electronic components which are designed for determining the items of information, for example an electronic table and in particular at least one look-up table and/or at least one application-specific integrated circuit (ASIC).

Further, the evaluation unit can also be designed to completely or partially control or drive the spectrometer system or a part thereof, for example by the evaluation unit being designed to control at least one illumination source and/or to control the optical element. The evaluation unit can, in particular, be designed to carry out at least one measurement cycle in which a plurality of sensor signals are picked up, especially, the sensor signals of successively arranged individual sensor pixels along the detector array. Herein, acquiring the sensor signals can be performed sequentially, in particular, by using a row scan and/or line scan. However, other embodiments are also possible, for example, embodiments in which especially selected individual pixel sensors are recorded simultaneously.

In a further aspect of the present invention, a use of a spectrometer system according to the present invention is disclosed. Therein, the use of the spectrometer system for a purpose of determining information related to a spectrum of an object is proposed. Herein, the spectrometer system may, preferably, be used for a purpose of use selected from the group consisting of: an infrared detection application; a spectroscopy application; an exhaust gas monitoring application; a combustion process monitoring application; a pollution monitoring application; an industrial process monitoring application; a chemical process monitoring application; a food processing process monitoring application; a water quality monitoring application; an air quality monitoring application; a quality control application; a temperature control application; a motion control application; an exhaust control application; a gas sensing application; a gas analytics application; a motion sensing application; a chemical sensing application; a mobile application; a medical application; a mobile spectroscopy application; a food analysis application; an agricultural application such as characterization of soil, silage, feed, crop or produce, monitoring plant health; a plastics identification and/or recycling application. Further applications are feasible.

The above-described detector array and the spectrometer system as well as the proposed uses have considerable advantages over the prior art. Thus, generally, a simple and, still, efficient detector array and spectrometer system for an accurate determining of information related to a spectrum may be provided. Therein, as an example, an infrared spectrum covering a partition of the infrared spectral range can be acquired in a fast and efficient way. As compared to devices known in the art, the detector array and the spectrometer system as proposed herein provide a high degree of simplicity, specifically with regard to an optical setup of the spectrometer system. Herein, a detector array which may specifically be adapted to at least one of an expected spectrum, a sensitivity of the optical sensors and an optical property of the spectrometer system may be advantageous since it allows a high degree of simplicity and, in combination with the possibility of fast measurements, it is specifically suited for sensing, detecting and/or monitoring applications in the IR spectral region, especially in at least one of the NIR and MidIR spectral regions. Further applications are possible.

Summarizing, in the context of the present invention, the following embodiments are regarded as particularly preferred:
Embodiment 1: A detector array, comprising:
   a substrate; and
   a plurality of detector pixels applied to a surface of the substrate,
   wherein each detector pixel has a sensor region which is designated for receiving a partition of incident light,
   wherein each detector pixel is designated for generating a sensor signal depending on an intensity of the partition of the incident light received by the sensor region of the detector pixel, and
   wherein the sensor regions of at least two of the detector pixels differ with respect to each other by an area of the corresponding sensor region.
Embodiment 2: The detector array according to the preceding embodiment, wherein the detector pixels are arranged on the substrate in a single line, thereby specifying a line of orientation of an arrangement of the detector pixels within the detector array.
Embodiment 3: The detector array according to any the preceding embodiment, wherein the area of each sensor region is aligned in a first direction and in a second direction.
Embodiment 4: The detector array according to any the preceding embodiment, wherein the first direction is parallel to the line of orientation of the arrangement of the detector pixels within the detector array.
Embodiment 5: The detector array according to any one of the two preceding embodiments, wherein the second direction is perpendicular to the line of orientation of the arrangement of the detector pixels within the detector array.
Embodiment 6: The detector array according to any one of the three preceding embodiments, wherein the sensor regions of the at least two of the detector pixels differ with respect to each other by an extension in at least one of the first direction and the second direction.
Embodiment 7: The detector array according to any one of the preceding embodiments, wherein the at least two of the detector pixels further differ with respect to each other by at least one of: a distance between the detector pixels, and a density of the detector pixels on a respective section of the substrate.
Embodiment 8: The detector array according to any one of the preceding embodiments, wherein each of at least two adjacent detector pixels comprises an individual connection to an individual power supply.
Embodiment 9: The detector array according to any one of the preceding embodiments, wherein at least two adjacent detector pixels share a single connection to a common electric potential.
Embodiment 10: The detector array according to the preceding Embodiment, wherein the common electric potential interconnects the electrodes of the detector pixels having the same polarity which are located on the same surface of the detector array.
Embodiment 11: The detector array according to any one of the two preceding
Embodiments, wherein a first number and a second number of the detector pixels are individually interconnected by a first common electric potential and a second common electric potential.
Embodiment 12: The detector array according to any one of the preceding embodiments, wherein the detector pixel is selected from at least one of: a pixelated organic camera element, preferably a pixelated organic camera chip; a photoconductor array, in particular an inorganic photoconductor array, especially a PbS, PbSe, Ge, InGaAs, ext. InGaAs, InSb, or HgCdTe photoconductor array; a pyroelectric, bolometer or thermopile array; a pixelated inorganic camera element, preferably a pixelated inorganic camera chip, more preferably from a CCD chip or a CMOS chip; a monochrome camera element, preferably a monochrome camera chip; a FIP sensor.
Embodiment 13: The detector array according to any one of the preceding embodiments, wherein the sensor region comprises a photosensitive material.
Embodiment 14: The detector array according to any one of the preceding embodiments, wherein the photosensitive material is a photoconductive material.
Embodiment 15: The detector array according to the preceding embodiment, wherein the area of the detector pixels defines an electrical resistivity of the detector pixels.
Embodiment 16: The detector array according to the preceding embodiment, wherein the areas of the at least two of the detector pixels are adjusted to align the electrical resistivity of the sensor regions.
Embodiment 17: The detector array according to the preceding embodiment, wherein the areas of the at least two of the detector pixels are adjusted to ensure the same electrical resistivity within the at least two of the detector pixels.
Embodiment 18: The detector array according to any one of the preceding embodiments, wherein the incident light comprises electromagnetic radiation of 760 nm to 1000 μm (infrared spectral range).
Embodiment 19: The detector array according to the preceding embodiment, wherein the incident light comprises electromagnetic radiation of 1 μm to 3 μm.
Embodiment 20: The detector array according to any one of the preceding embodiments, wherein the light beam is generated by a reflection of the primary radiation on an object and/or by light emission by the object itself, stimulated by the primary radiation.
Embodiment 21: A spectrometer system, comprising
   a wavelength selective filter which is designated for separating incident light into a spectrum comprising a plurality of partitions of the incident light; and
   a detector array according to any one of the preceding claims; and
   an evaluation unit designated for determining information related to a spectrum by evaluating the sensor signals provided by the detector array.
Embodiment 22: The spectrometer system according to the preceding embodiment, wherein the evaluation unit is designed to generate the information related to the spectrum from at least one predefined relationship between the location of the detector pixels in the detector array, the wavelength of the incident light, and the sensor signal.
Embodiment 23: The spectrometer system according to the preceding embodiment, wherein the sensor signal is generated by performing at least one current-voltage measurement and/or at least one voltage-current-measurement.
Embodiment 24: The spectrometer system according to any one of the preceding embodiments related to the spectrometer system, further comprising an illumination source adapted for illuminating the object.
Embodiment 25: The spectrometer system according to the preceding embodiment, wherein the illumination source is selected from at least one of: an incandescent lamp; a thermal infrared emitter; a flame source; a heat source; a laser, in particular a laser diode; a light emitting diode; an organic light source, in particular an organic light emitting diode; a neon light; a structured light source.
Embodiment 26: The spectrometer device according to any one of the two preceding embodiments, wherein the illumination source is integrated or attached to the spectrometer device.
Embodiment 27: The spectrometer device according to any one of the preceding embodiments related to the spectrometer system, further comprising an optical element designed for receiving incident light from the object and transferring the incident light to the wavelength selective filter.
Embodiment 28: The spectrometer device according to the preceding embodiment, wherein the optical element is selected from an optical concentrator device being operated in reverse direction, or a transfer device.
Embodiment 29: The spectrometer device according to any one of the preceding embodiments related to the spectrometer system, further comprising a transfer device.
Embodiment 30: The spectrometer device according to any one of the two preceding embodiments, wherein the transfer device constitutes or comprises a converging optical element, wherein the converging element is at least partially optically transparent with respect to at least a partition of a wavelength range of the incident light.
Embodiment 31: The spectrometer device according to the preceding embodiment, wherein the converging optical element is selected from a group consisting of a converging optical lens, converging diffractive optical element and a converging curved mirror.
Embodiment 32: The spectrometer device according to any one of the three preceding embodiments, wherein the transfer device is located between the optical concentrator device and the length variable filter.
Embodiment 33: The spectrometer device according to any one of the preceding embodiments, wherein the detector array is separated from the wavelength selective filter by a transparent gap.
Embodiment 34: A use of a spectrometer device or a spectrometer system according to any one of the preceding embodiments in an infrared detection application; a spectroscopy application; an exhaust gas monitoring application; a combustion process monitoring application; a pollution monitoring application; an industrial process monitoring application; a chemical process monitoring application; a food processing process monitoring application; a water quality monitoring application; an air quality monitoring application; a quality control application; a temperature control application; a motion control application; an exhaust control application; a gas sensing application; a gas analytics application; a motion sensing application; a chemical sensing application; a mobile application; a medical application; a mobile spectroscopy application; a food analysis application; an agricultural application such as characterization of soil, silage, feed, crop or produce, monitoring plant health; a plastics identification and/or recycling application.

### BRIEF DESCRIPTION OF THE FIGURES

Further optional details and features of the invention are evident from the description of preferred exemplary embodiments which follows in conjunction with the dependent claims. In this context, the particular features may be implemented alone or with features in combination. The invention is not restricted to the exemplary embodiments. The exemplary embodiments are shown schematically in the figures. Identical reference numerals in the individual figures refer to identical elements or elements with identical function, or elements which correspond to one another with regard to their functions.

Specifically, in the figures:

FIG. 1 shows a schematic view of an exemplary embodiment of a spectrometer system comprising a detector array according to the present invention;

FIG. 2 shows a front view of a detector array according to the state of the art;

FIGS. 3 and 4 show front views of preferred exemplary embodiments of the detector array according to the present invention; and

FIGS. 5 and 6 show front views of the preferred exemplary embodiments of the detector array according to the present invention additionally illustrating different embodiments for power supply.

### EXEMPLARY EMBODIMENTS

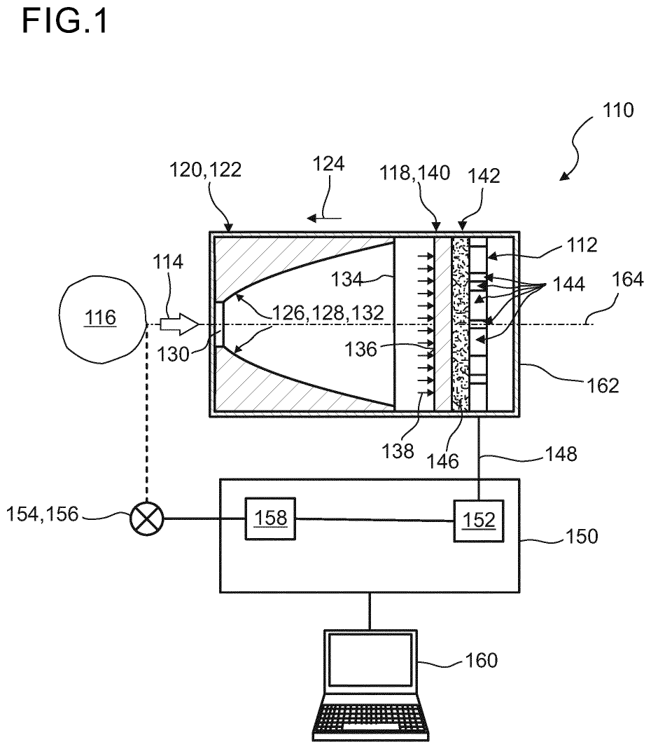

FIG. 1 illustrates, in a highly schematic fashion, an exemplary embodiment of a spectrometer system 110 which comprises a detector array 112 according to the present invention. As generally used, the spectrometer system 110 is designated for recording a signal intensity of incident light 114 with respect to a corresponding wavelength or a wavelength interval of the incident light 114 over a range of wavelengths which is denoted as a “spectrum” or as a partition thereof. According to the present invention, the spectrometer system 110 may, especially, be adapted for recording a spectrum in the infrared (IR) spectral region, preferably, in at least one of the near-infrared (NIR) and the mid-infrared (MidIR) spectral ranges, especially, wherein the incident light may have a wavelength of 1 μm to 5 μm, preferably of 1 μm to 3 μm, and can, thus, be applicable for investigation or monitoring purposes, in particular in the IR spectral region. Herein, the incident light 114 may be generated and/or reflected by an object 116, which may be a living object and a non-living object, such as comprising one or more articles and/or one or more parts of an article, wherein the at least one article or the at least one part thereof may comprise at least one component which can provide a spectrum which may be suitable for investigations in the IR, especially in the NIR spectral region.

The exemplary spectrometer system 110 as schematically depicted in FIG. 1 comprises a linearly variable filter 118 as a preferred example of a wavelength selective filter, wherein the linearly variable filter 118 is designated for separating the incident light 114 into a spectrum comprising a plurality of wavelength-resolved partitions of the incident light 114, the detector array 112 which is designed for determining respective intensities of received wavelength signals, and an optical element 120 which is designated for the receiving incident light 114 from the object 116 and transferring the incident light 114 to the linearly variable filter 118. In general, at least one transfer device (not depicted here), preferably a refractive lens, may be used as the optical element 120.

As schematically depicted in FIG. 1, the optical element 120 may, alternatively or in addition, comprise an optical concentrator device 122, wherein the optical concentrator device 122 may be operated in reverse direction 124. Herein, the inversely-operated optical concentrator device 122 may comprise a non-conical shape 126, in particular a parabolic shape 128. However, other kinds of shapes, specifically a conical shape or a different kind of non-conical shape 126, such as an elliptical shape, may also be feasible. As illustrated here, the inversely-operated optical concentrator device 124 comprises an input 130, an optically guiding structure 132 and an output 134. Consequently, the incident light 114, which may be emitted or reflected by the object 116 or may have passed through the object 116, enters the inversely-operated optical concentrator device 122 at the input 130 which is designed for receiving the incident light 114. Thereafter, the incident light 114 captured by the input 130 passes through the optically guiding structure 132 which is, preferably, designed for spreading out the incident light 114. Finally, the incident light 114 which has been spread out in this manner is emitted by the output 134 which is being designated for this purpose. Thus, an angular spread of light beams which are emitted at the output 134 can, simultaneously, be reduced compared to the angular spread of the incident light 114. As a result, the inversely-operated optical concentrator device 122 allows modifying the incident light 114 as provided by the object 116 in a manner that the light which is emitted at the output 134 of the inversely-operated optical concentrator device 124 exhibits a reduced angular spread.

Consequently, a predominant share of the light beams provided by the output 134 of the inversely-operated optical concentrator device 122 impinges the linearly variable filter 118 in a parallel manner, especially, normal to a receiving surface 136 of the linearly variable filter 118 in a perpendicular manner. As used in this exemplary embodiment, the linearly variable filter 118 is or comprises an optical filter having a plurality of interference filters which are, preferably, provided in a continuous arrangement of interference filters. Herein, each of the interference filters may form a bandpass with a variable center wavelength for each spatial position 138 on the receiving surface 136 of the linearly variable filter 118 in a manner that the variable center wavelength may be a linear function of the spatial position 138.

As exemplary shown in FIG. 1, the linearly variable filter 118 may, thus, be arranged, preferably continuously, along a single dimension, usually as “length” of the linearly variable filter 118. By way of example, the linearly variable filter 118 may be a wedge filter that may carry at least one response coating 140 on a transparent substrate 142, wherein the response coating 140 may exhibit a spatially variable property, in particular, a spatially variable thickness (not depicted here). Herein, the transparent substrate 142 may comprise at least one material that may exhibit a high degree of optical transparency in the IR spectral range which can, preferably, be selected from the group consisting of calcium fluoride (CaF₂,), fused silica, germanium (Ge), magnesium fluoride (MgF), potassium bromide (KBr), sapphire, silicon (Si), sodium chloride (NaCl), zinc selenide (ZnSe), zinc sulfide (ZnS), borosilicate glasses, transparent conducting oxides (TCO), and transparent organic polymers, wherein CaF₂, fused silica, MgF, KBr, sapphire, Si, NaCl, ZnSe, ZnS, borosilicate glasses, transparent conducting oxides, and selected transparent organic polymers may, especially, be applicable for the NIR spectral range. However, other embodiments of the linearly variable filter 118 may also be feasible. However, other kinds of length variable filters may also be feasible for the purposes of the present invention.

The linearly variable filter 118 is designated for separating the incident light 114 into a spectrum comprising a plurality of wavelength-resolved partitions of the incident light 114. For this purpose, the incident light 114 may, preferably, pass through the linearly variable filter 118 at the particular spatial position 138 which is related to the wavelength of the incident light 114. After the incident light 114 has passed through the linearly variable filter 118 at the particular spatial position 138 related to the wavelength of the incident light 114, it, subsequently, impinges the detector array 112, in particular one of a plurality of sensor pixels 144 as comprised by the detector array 112. Thus, each of the sensor pixels 144 receives at least a portion of one of the constituent wavelength signals as provided by the incident light 114 after having passed through the linearly variable filter 118 as described above. Moreover, each of the sensor pixels 144 is adapted to provide a sensor signal which is related to an intensity of each constituent wavelength. In other words: The spectrometer system 110 is, thus, designated to generate a plurality of sensor signals based on the constituent wavelength signals, wherein each of the sensor signals is related to the intensity of each partition of the incident light 114.

As further indicated in FIG. 1, the detector array 112 may, preferably, be separated from the linearly variable filter 118 by a transparent gap 146, wherein the transparent gap 146 may, by way of example, be obtained by using the transparent substrate 142. As a result, by selecting a suitable width for the transparent gap 146 a more precise adjustment of the detector array 112 with regard to the linearly variable filter 118 can be achieved. In addition, adjusting the transparent gap 146 may allow further increasing the efficiency of the spectrometer system 110.

The plurality of sensor signals may, as schematically depicted in FIG. 1, via a signal lead 148 be transmitted to an evaluation unit 150 as further comprised by the spectrometer system 110. Herein, the evaluation unit 150 is, generally, designated for determining information related to a spectrum of the object 116 by evaluating the plurality of sensor signals as provided by the detector array 112. For this purpose, the evaluation unit 150 may comprise one or more electronic devices and/or one or more software components, in order to evaluate the plurality of the sensor signals, which are symbolically denoted by a signal evaluation unit 152. Herein, the evaluation unit 150 may be adapted to determine the at least one item of information related to a spectrum of the object 116 by comparing more than one of the sensor signals.

The incident light 114 which is received by the optical element 120 of the spectrometer device 112 may be generated by a light-emitting object 116. Alternatively or in addition, the incident light 114 may be generated by a separate illumination source 154, which may include an ambient light source and/or an artificial light source, in particular an incandescent lamp 156, which may be designated for illuminating the object 116 in a manner that at least a part of the light generated by the illumination source 154 may be able to pass through the object 116 (not depicted here) and/or in a manner that the object 116 may be able to reflect at least a part of the light generated by the illumination source 154 such that the incident light 114 may be configured to be received by the optical element 120. Herein, the illumination source 154 may be or comprise a continuously emitting light source and/or a modulated light source. As further depicted in FIG. 1, the illumination source 154 may be controlled by at least one illumination control unit 158 which may be adapted, if required, for providing modulated light. Herein, the illumination control unit 158 may, additionally, provide information about the illumination to the signal evaluation unit 152 and/or be controlled by the signal evaluation unit 152, which is symbolically indicated by a lead between the illumination control unit 158 and the signal evaluation unit 152 in FIG. 1. Alternatively or in addition, controlling the illumination of the object 116 may be effected in a beam path between the illumination source 154 and the object 116 and/or between the object 116 and the optical element 120. Further possibilities may be conceivable.

Generally, the evaluation unit 150 may be part of a data processing device 160 and/or may comprise one or more data processing devices 160. The evaluation unit 150 may be fully or partially integrated into a housing 162 which may further comprise the detector array 112, the linearly variable filter 118 and the optional optical element 120, and/or may fully or partially be embodied as a separate device which may electrically be connected in a wireless or wire-bound fashion to the detector array 112. The evaluation unit 150 may further comprise one or more additional components, such as one or more electronic hardware components and/or one or more software components, such as one or more measurement units and/or one or more evaluation units and/or one or more controlling units (not depicted here).

As further illustrated in the exemplary embodiment of FIG. 1, the detector array 112, the linearly variable filter 118, and the optical element 120 may, in this particular embodiment, arranged along a common optical axis 164. Specifically, the optical axis 164 may be an axis of symmetry and/or rotation of the setup of at least one of the detector array 112, the linearly variable filter 118, and the optical element 120. Especially, the optical axis 164 may, thus, be parallel to a plane which is perpendicular to the receiving surface 136 of the linearly variable filter 118.

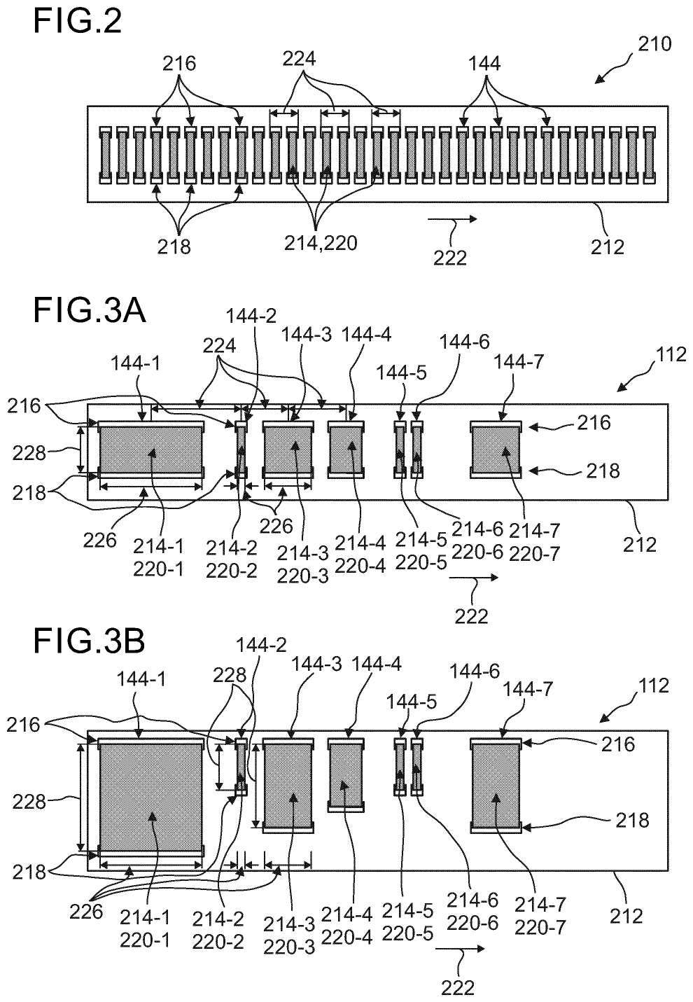

FIG. 2 illustrates an example of a front view of a known detector array 210 according to the state of the art, wherein the front of the detector array 210 is directed towards the linearly variable filter 118. As illustrated here, the detector array 210 comprises a substrate 212 which carries the plurality of the sensor pixels 144, wherein each sensor pixel 144 has a sensor region 214 which is designated for receiving a partition of the incident light 114. Herein, each sensor pixel 144 is designated for generating a sensor signal depending on an intensity of the partition of the incident light 114 being received by the corresponding sensor region 214. For this purpose, two electrodes 216, 218 of different polarity may be attached to a boundary of each sensor region 214 for receiving electric charges which may be generated by the incident light 114 within the corresponding sensor region 214. Thus, the sensor pixel 144 is designed to generate the sensor signals, preferably in form of electronic signals, which are associated with the intensity of the incident light 114 impinging on the individual sensor pixel 144.

As shown in FIG. 2, each of the sensor regions 214 in the plurality of the sensor pixels 144 in the known detector array 210 exhibits an identical shape, has a same size of the area 220, and is placed on the substrate 212 in a single line of orientation 222 along a direction of the single line in an equidistant manner having identical distances 224 between the centers of adjacent sensor pixels 144. As a consequence thereof, the known detector array 210 is designed for recording and generating a high-resolution spectrum, wherein a multitude of peaks in the spectrum can be determined each by forming an integral using the sensor signals of the respectively involved detector pixels 144 by using a computer program which is configured for this purpose.

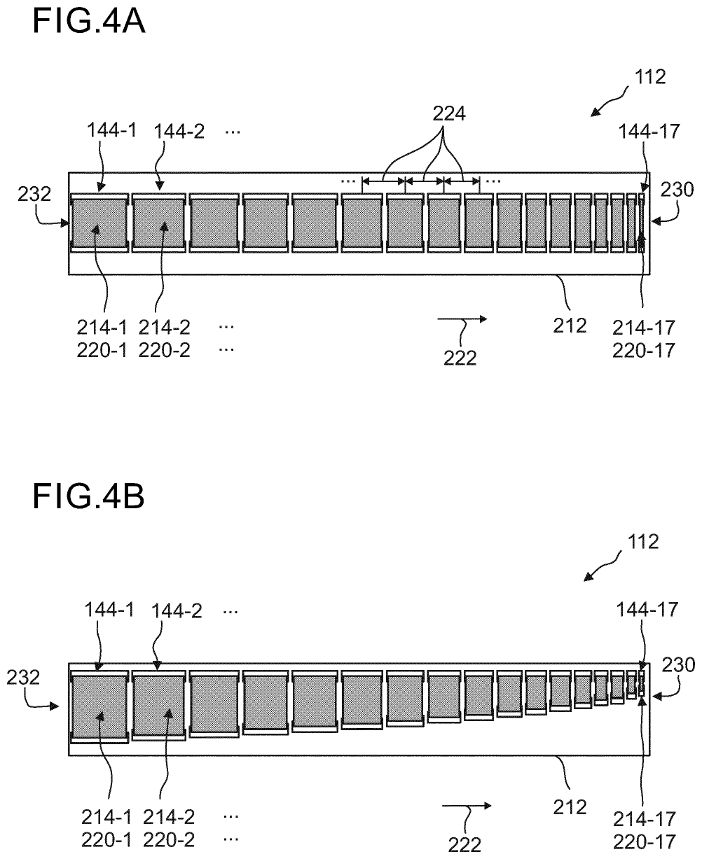

In contrast to FIG. 2 which schematically depicts a typical embodiment of the known detector array 210 according to the state of the art, FIGS. 3 and 4 illustrate various preferred exemplary embodiments of the detector array 112 according to the present invention. Herein, the exemplary embodiments of the detector array 112, again, comprises the substrate 212 and the plurality of the detector pixels 144 which are applied to a front surface of the substrate 212. Further, each detector pixel 144, again, has a sensor region 214 which is designated for receiving a partition of the incident light 114, wherein each detector pixel 144 is, again, designated for generating a sensor signal depending on an intensity of the partition of the incident light 114 which is being received by the sensor region 214 of the corresponding detector pixel 144. However, in contrast to the known detector array 210 according to the state of the art as depicted in FIG. 2, the sensor regions 214 of at least two of the detector pixels 144 in FIGS. 3 and 4 differ with respect to each other by a size of the respective area 220 of the corresponding sensor region 214.

In the preferred exemplary embodiments of the detector array 112 according to the present invention as illustrated in FIGS. 3A and 3B, each of the detector arrays 112 has, by way of example, seven different detector pixels 144-1, 144-2, 144-3, 144-4, 144-5, 144-6, and 144-7,
wherein the sizes of the respective areas 220-1, 220-3, 220-4, and 220-7 of the corresponding sensor regions 214-1, 214-3, 214-4, and 214-7 of the detector pixels 144-1, 144-3, 144-4, and 144-7 differ with respect to each other and with respect to the other detector pixels 114-2, 144-5 and 144-6,
while the other detector pixels 114-2, 144-5 and 144-6 exhibit the same size for the areas 220-2, 220-5 and 220-6 for the corresponding sensor regions 214-2, 214-5, 214-6, but, still, differ from the detector pixels 144-1, 144-3, 144-4, and 144-7.

As indicated above, other preferred exemplary embodiments of the detector array 112 may comprise a different number N 5 of detector pixels 144, however, preferably N 25, more preferred N≤10.

Consequently, the sensor regions 214 of at least two of the detector pixels 114 in the preferred exemplary embodiments of the detector array 112 of FIGS. 3A and 3B differ with respect to each other by a size of the respective area 220 of the corresponding sensor region 214. As further indicated therein, the two electrodes 216, 218 of different polarity which are attached to the boundary of the sensor region 214 of each individual detector pixel 144, accordingly, exhibits a size and shape which is adjusted to the actual size and shape of the sensor region 214 in a fashion that an extension of each electrode 216, 218 varies in accordance with the corresponding extension of the respective sensor region 214 where it is attached to.

Comparing the detector array 112 of FIG. 3A with the detector array 210 in FIG. 2 according to the state of the art, a density of the detector pixels 144 on a respective section of the substrate 212 differs in both embodiments. As a consequence, a frequency of occurrence of the detector pixels 144-1, 144-2, 144-3, 144-4, 144-5, 144-6, and 144-7 in the embodiment of FIG. 3A varies over each section of the substrate 212 compared to a single frequency of occurrence of the detector pixels 144 in the embodiment of FIG. 2. By way of example, the section could be defined by a surface area given by a width of the substrate 212 and a value of the distance 224 between the centers of adjacent sensor pixels 144 as illustrated in FIG. 2. Whereas the density of the detector pixels 144 on this section is 1 in FIG. 2, it differs from section to section in FIG. 3A. Similar considerations can be performed for the other embodiments of FIGS. 3B, 4A, 4B, 5A, 5B, 6A, and 6B.

As illustrated in FIG. 3A, the size of the areas 220 of the detector pixels 144 can only be varied along the line of orientation 222 with regard to the substrate of the detector array 212 which can be denoted by a width 226, whereas a length 228 of each detector pixel 144 may be maintained constant. Such a kind of embodiment can, in general, be advantageous since it may facilitate manufacturing of the detector array 112.

However, as illustrated in FIG. 3B, the size of the areas 220 of the detector pixels 144 cannot only be varied with respect to the width 226, i.e. along the line of orientation 222 but also with regard to the length 228 of each detector pixel 144 constant. In this particularly preferred embodiment, the corresponding areas 220 of the detector pixels 144 can, therefore, preferably be adjusted in order to align an electrical resistivity of the respective sensor regions 214 of the detector pixels 144. Consequently, each detector pixel 144 exhibits the same or a very similar electrical resistivity. Such a kind of embodiment can, particularly, be advantageous in a case in which the photosensitive material of the senor regions 214 is chosen from a photoconductive material as indicated above. Thus, the electrical conductivity of the corresponding sensor regions 214 of the detector pixels 144 could, equally, be adjusted. As a result thereof, an amplification factor for amplifying the sensor current can, advantageously, be chosen as equal for all detector pixels 114 in this kind of detector array 112, in which the sensor regions 214 comprise the same photoconductive material.

Thus, using the detector arrays 112 of FIGS. 3A and 3B in which the area 220 of each detector pixel 144 is adapted to peaks which are expected to occur in the spectrum to be investigated or monitored facilitates integration of the sensor signals by reducing the number of detector pixels 144 within the detector array 112 according to the present invention roughly to the number of peaks to be integrated for generating the sensor signal. In particular since the linearly variable filter 118 is fixed, the peaks always appear at the same position within the spectrum which, thus, allows placing the corresponding detector pixel 144 at the same location on the detector array 112. In addition, a formation of a ratio of integrals can even be determined by using analogue electronics which make use of the sensor signals of two detector pixels 144 which are assigned to peaks whereof a ratio is desired to be determined.

In the further preferred exemplary embodiments of the detector array 112 according to the present invention as illustrated in FIGS. 4A and 4B, each of the detector arrays 112 has, by way of example, seventeen different detector pixels 144-1, 144-2, . . . 144-17, wherein the sizes of the respective areas 220-1, 220-2, . . . 220-17 of the corresponding sensor regions 214-1, 214-2, . . . 214-17 of the detector pixels 144-1, 144-2, . . . 144-7 differ with respect to each other in a fashion that the sizes of the respective areas 220-1, 220-2, . . . 220-17 are adjusted to a spectral property of the partition of the incident light 114 which impinges on the corresponding sensor regions 214-1, 214-2, . . . 214-17 of the detector pixels 144-1, 144-2, . . . 144-7, preferably after having passed the linearly variable filter 118. As schematically depicted in FIGS. 4A and 4B, the variation of the sizes of the respective areas 220-1, 220-2, . . . 220-17 may follow a dependence of the bandwidth of the linearly variable filter 118 with regard to the location in the linearly variable filter 118 and, since the detector array 112 can be maintained in a fixed position with respect to the linearly variable filter 118, also in the detector array 112. In an embodiment in which the linearly variable filter 118 may be more selective at a first end 230 designed for receiving long wavelengths compared to a second end 232 designed for receiving a short wavelengths, the sizes of the respective areas 220-1, 220-2, . . . 220-17 may vary as illustrated in FIGS. 4A and 4B. In addition, it is emphasized that the difference between FIGS. 4A and 4B corresponds to the difference between FIGS. 3A and 3B as described above.

In further preferred exemplary embodiments of the detector array 112 according to the present invention (not depicted here) the sizes of the respective areas 220-1, 220-2, . . . 220-17 may vary with respect to a variation of an emission spectrum of the illumination source 154 which illuminates the object 116 generating the spectrum so that a linear or a flat spectrum can be obtained when the incident light 114 having this type of emission spectrum directly illuminates the detector array 112. However, additional embodiments of the detector array 112 are conceivable.

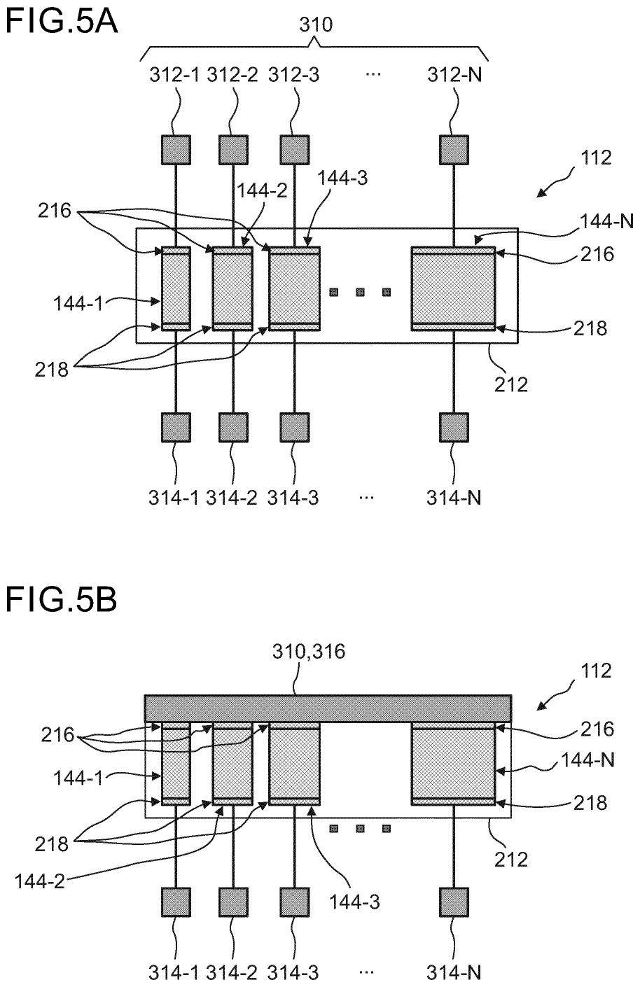

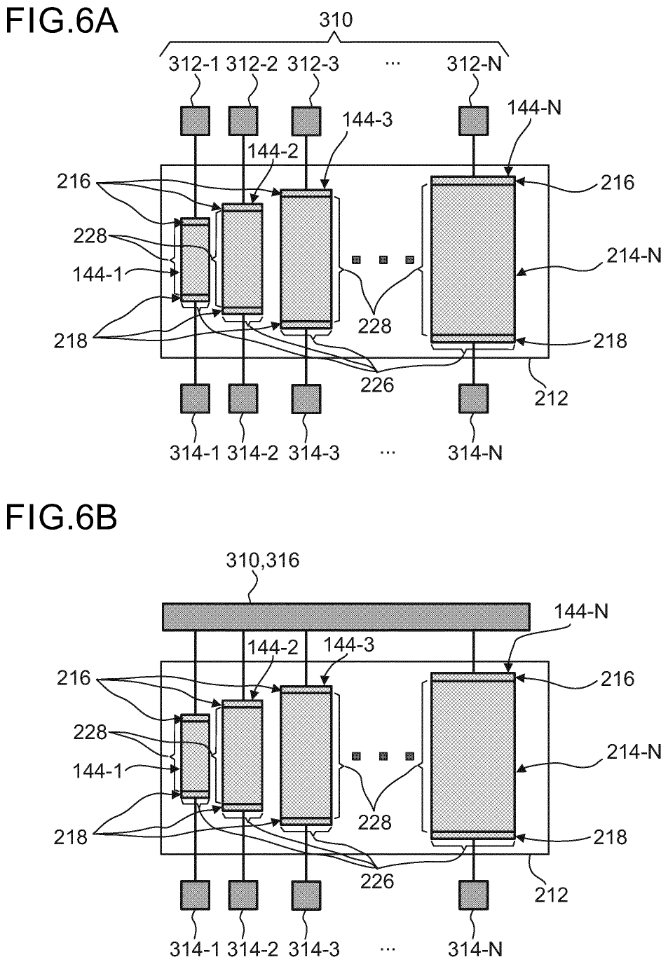

Further, FIGS. 5 and 6 show preferred exemplary embodiments of the front views of the detector array 112 according to the present invention, wherein the two different types of connection between adjacent detector pixels 144 with respect to an application of a power supply 310 to the detector pixels 144 of the detector array 112 are additionally illustrated. Herein, the detector arrays 112 of FIGS. 5A and 5B correspond to the detector arrays 112 of FIG. 3A while the detector arrays 112 of FIGS. 6A and 6B are similar to the detector arrays 112 of FIG. 4B. Similar embodiments (not depicted here) could also be provided for the detector arrays 112 of FIGS. 3B and 4A. For further details, reference can be made to the above description of FIGS. 3 and 4. In addition, further embodiments can be conceived, in particular, embodiments in which some of the detector pixels 144-1, 144-2, 144-3, . . . 144-N have a kind of power supply in accordance with a first embodiment while others of the detector pixels 144-1, 144-2, 144-3, . . . 144-N have a different kind of power supply in accordance with a different embodiment.

In a first embodiment of the power supply 310 as schematically depicted in FIG. 5A, individual power supplies 312-1, 312-2, 312-3, . . . 312-N are provided for each detector pixel 144-1, 144-2, 144-3, . . . 144-N. As advantage thereof, a current through and a responsivity for each detector pixel 144-1, 144-2, 144-3, . . . 144-N can be adjusted individually by using the individual power supplies 312-1, 312-2, 312-3, . . . 312-N. However, each detector pixel 144-1, 144-2, 144-3, . . . 144-N has an individual power supply 312-1, 312-2, 312-3, . . . 312-N in this embodiment, wherein a noise of the current through each detector pixel 144-1, 144-2, 144-3, . . . 144-N can differ with respect from each other. The embodiment of FIG. 5A may, in particular, be used in a case in which individual power supplies 312-1, 312-2, 312-3, . . . 312-N and corresponding individual read-out electronics 314-1, 314-2, 314-3, . . . 314-N can easily be provided for the detector pixels 144-1, 144-2, 144-3, . . . 144-N. Herein, an increase of efficiency of the detector array 112 can be obtained in an event in which the wavelengths impinging on the detector array 112 differ with respect to their respective band-with, wherein a linearization of the sensor signals of each detector pixel 144-1, 144-2, 144-3, . . . 144-N in the detector array 112 can be achieved by using the individual read-out electronics 314-1, 314-2, 314-3, . . . 314-N in an adapted fashion.

In a further embodiment of the power supply 310 as schematically depicted in FIG. 5B, a common electric potential 316 is provided for all detector pixels 144-1, 144-2, 144-3, . . . 144-N, thus, generating interconnection between the electrodes 216 of all detector pixels 144-1, 144-2, 144-3, . . . 144-N. As advantage thereof, the common electric potential 316 can be manufactured more easily using lithography compared to the individual power supplies 312-1, 312-2, 312-3, . . . 312-N of FIG. 5A. The embodiment of FIG. 5B may, in particular, be used in a case in which the individual read-out electronics 314-1, 314-2, 314-3, . . . 314-N can easily be adjusted to the corresponding detector pixel 144-1, 144-2, 144-3, . . . 144-N by generating only a single power voltage. Also here, an increase of efficiency of the detector array 112 can be obtained in an event in which the wavelengths impinging on the detector array 112 differ with respect to their respective band-with, wherein a linearization of the sensor signals of each detector pixel 144-1, 144-2, 144-3, . . . 144-N in the detector array 112 can also here be achieved by using the individual read-out electronics 314-1, 314-2, 314-3, . . . 314-N accordingly.

In the further embodiment of the power supply 310 as schematically depicted in FIG. 6A, the individual power supplies 312-1, 312-2, 312-3, . . . 312-N are—similar to the embodiment of FIG. 5A—provided for each detector pixel 144-1, 144-2, 144-3, . . . 144-N. As advantages thereof, the current through and a responsivity for each detector pixel 144-1, 144-2, 144-3, . . . 144-N can also here be adjusted individually by using the individual power supplies 312-1, 312-2, 312-3, . . . 312-N. In addition, each detector pixel 144-1, 144-2, 144-3, . . . 144-N exhibits the same aspect ratio, i.e. the same relation of the length 228 versus the width 226 of each detector pixel 144-1, 144-2, 144-3, . . . 144-N. As a particular advantage thereof, an electrical resistivity of the corresponding sensor regions 214-1, 214-2, 214-3, . . . 214-N of the detector pixels 144-1, 144-2, 144-3, . . . 144-N are aligned in a fashion that each detector pixel 144-1, 144-2, 144-3, . . . 144-N exhibits a dark resistance in the same order of magnitude. Consequently, the noise of the currents through the different detector pixels 144-1, 144-2, 144-3, . . . 144-N can assume a value within the same range. For further advantages and uses, please refer to the description of FIG. 5A.

In the further embodiment of the power supply 310 as schematically depicted in FIG. 6B, the common electric potential 316 is—similar to the embodiment of FIG. 5B—provided for all detector pixels 144-1, 144-2, 144-3, . . . 144-N, thus, also generating here interconnection between the electrodes 216 of all detector pixels 144-1, 144-2, 144-3, . . . 144-N. As advantage thereof, the common electric potential 316 can also here be manufactured more easily using lithography compared to the individual power supplies 312-1, 312-2, 312-3, . . . 312-N of FIG. 5A. The embodiment of FIG. 6B may, in particular, be used in a case in which the individual read-out electronics 314-1, 314-2, 314-3, . . . 314-N can easily be adjusted to the corresponding detector pixel 144-1, 144-2, 144-3, . . . 144-N by generating only a single power voltage. Also here, an increase of efficiency of the detector array 112 can be obtained in an event in which the wavelengths impinging on the detector array 112 differ with respect to their respective band-with, wherein a linearization of the sensor signals of each detector pixel 144-1, 144-2, 144-3, . . . 144-N in the detector array 112 can also here be achieved by using the individual read-out electronics 314-1, 314-2, 314-3, . . . 314-N accordingly. In addition, each detector pixel 144-1, 144-2, 144-3, . . . 144-N exhibits—similar to the embodiment of FIG. 6A—the same aspect ratio, i.e. the same relation of the length 228 versus the width 226 of each detector pixel 144-1, 144-2, 144-3, . . . 144-N, whereby the same particular advantage as indicated above that the electrical resistivity of the corresponding sensor regions 214-1, 214-2, 214-3, . . . 214-N of the detector pixels 144-1, 144-2, 144-3, . . . 144-N can be aligned in a fashion that the dark resistance of each detector pixel 144-1, 144-2, 144-3, . . . 144-N is in the same order of magnitude. Consequently, the noise of the currents through the different detector pixels 144-1, 144-2, 144-3, . . . 144-N can also here assume a value within the same range. For further advantages and uses, please refer to the description of FIGS. 5B and 6A.

### LIST OF REFERENCE NUMBERS

110 spectrometer system
112 detector array
114 incident light
116 object
118 linearly variable filter as a preferred example of a wavelength selective filter
120 optical element
122 inversely-operated optical concentrator device
124 reverse direction
126 non-conical shape
128 parabolic shape
130 input
132 guiding structure
134 output
136 receiving surface
138 spatial position
140 response coating
142 transparent substrate
144 detector pixel
146 transparent gap
148 signal lead
150 evaluation unit
152 signal evaluation unit
154 illumination source
156 incandescent lamp
158 illumination control unit
160 data processing device
162 housing
164 optical axis
210 known detector array according to the state of the art
212 substrate
214 sensor region
216 electrode
218 electrode
220 photosensitive area
222 line of orientation
224 distance
226 width
228 length
230 first end
232 second end
310 power supply
312 individual power supply
314 individual read-out electronics
316 common electric potential

1. A detector array comprising
a substrate; and
a plurality of detector pixels applied to a surface of the substrate,
wherein each detector pixel has a sensor region which is designated for receiving a partition of incident light,
wherein each detector pixel is designated for generating a sensor signal depending on an intensity of the partition of the incident light received by the sensor region of the detector pixel, wherein at least two adjacent detector pixels share a single connection to a common electric potential, and
wherein the sensor regions of at least two of the detector pixels differ with respect to each other by an area of the corresponding sensor region.

2. The detector array according to claim 1, wherein the detector pixels are arranged on the substrate in a single line, thereby specifying a line of orientation of an arrangement of the detector pixels within the detector array.

3. The detector array according to claim 2, wherein the area of each sensor region is aligned in a first direction and in a second direction, wherein the first direction is parallel to the line of orientation of the arrangement of the detector pixels within the detector array, and wherein the second direction is perpendicular to the line of orientation of the arrangement of the detector pixels within the detector array.

4. The detector array according to claim 3, wherein the sensor regions of the at least two of the detector pixels differ with respect to each other by an extension in at least one of the first direction and the second direction.

5. The detector array according to claim 1, wherein the at least two of the detector pixels further differ with respect to each other by at least one of: a distance between the detector pixels, and a density of the detector pixels on a respective section of the substrate.

6. The detector array according to claim 1, wherein the common electric potential interconnects the electrodes of the detector pixels having the same polarity which are located on the same surface of the detector array.

7. The detector array according to claim 1 wherein a first number and a second number of the detector pixels are individually interconnected by a first common electric potential and a second common electric potential.

8. The detector array according to claim 1, wherein the sensor region comprises a photosensitive material.

9. The detector array according claim 8, wherein the photosensitive material is a photoconductive material, wherein the area of the detector pixels defines an electrical resistivity of the detector pixels, wherein the areas of the at least two of the detector pixels are adjusted to align the electrical resistivity of the sensor regions.

10. The detector array according to claim 9, wherein the areas of the at least two of the detector pixels are adjusted to ensure the same electrical resistivity within the at least two of the detector pixels.

11. A spectrometer system, comprising
a wavelength selective filter which is designated for separating incident light into a spectrum comprising a plurality of partitions of the incident light;
a detector array according to claim 1; and
an evaluation unit designated for determining information related to a spectrum by evaluating the sensor signals provided by the detector array.

12. The spectrometer system according to claim 11, wherein the area of at least one of the detector pixels is adjusted to a spectral property of the partition of the incident light which impinges on the corresponding sensor region of the detector pixel after passing the wavelength selective filter.

13. The spectrometer system according to claim 12, wherein the spectral property is selected from at least one of the group consisting of: a width of a peak within the spectrum of the incident light, a bandwidth of the wavelength selective filter, a variation of an emission spectrum of an illumination source illuminating an object generating the spectrum.

14. The spectrometer system according to claim 13, wherein the area of the at least one of the detector pixels is adjusted to a variation of the bandwidth of the incident light after passing the wavelength selective filter.

15. The system according to claim 13, wherein the area of the at least one of the detector pixels is adjusted to the peak width to ensure that the sensor signal being provided by the at least one of the detector pixels corresponds to an intensity of the peak.

16. The spectrometer system according to claim 15, wherein the evaluation unit is designated for determining a relationship between an intensity of two different peaks by evaluating the sensor signals of the two detector pixels.

17. A method of using the spectrometer system according to claim 1, for a purpose selected from the group consisting of: an infrared detection application; a spectroscopy application; an exhaust gas monitoring application; a combustion process monitoring application; a pollution monitoring application; an industrial process monitoring application; a mixing or blending process monitoring; a chemical process monitoring application; a food processing process monitoring application; a food preparation process monitoring; a water quality monitoring application; an air quality monitoring application; a quality control application; a temperature control application; a motion control application; an exhaust control application; a gas sensing application; a gas analytics application; a motion sensing application; a chemical sensing application; a mobile application; a medical application; a mobile spectroscopy application; a food analysis application; an agricultural application such as characterization of soil, silage, feed, crop or produce, monitoring plant health; and a plastics identification and/or recycling application.
